(19) United States
(12) Patent Application Publication
(10) Pub. No.: US 2013/0204638 A1
(43) Pub. Date: Aug. 8, 2013

(54) Systems and Methods for Managing Eligible Expenses From Specialized Financial Accounts

(71) Applicant: THE MSA CARD, LLC, Sanford, FL (US)

(72) Inventors: Matan Lan, Orlando, FL (US); Robert David Barson, Winter Springs, FL (US)

(73) Assignee: THE MSA CARD, LLC, Sanford, FL (US)

(21) Appl. No.: 13/826,925

(22) Filed: Mar. 14, 2013

(51) Int. Cl. G06Q 50/22; G06Q 40/02

(52) U.S. Cl. CPC G06Q 50/22; G06Q 40/02
USPC 705/2

(57) ABSTRACT

Disclosed herein are systems and related methods for administering a financial account on behalf of a system member, where payments from the financial account are restricted to only eligible expenses. Such administration of a restricted-use financial account assists members in properly expending funds from their financial account, and thus maintaining compliance with any guidelines or laws regulating the expenditure of funds from their account. In a more specific aspect, the disclosed principles provide a solution for Medicare Set Aside (MSA) account payments by which individuals may self-administer one or more MSA accounts on their own behalf, yet ensure compliance with the guidelines and laws governing such MSA accounts, such as CMS.

### TECHNICAL FIELD

The present disclosure relates generally to administering restricted-use financial accounts for individuals, and more specifically to the administration of accounts and payments implemented under the Medicare Secondary Payer Act.

### BACKGROUND

The Medicare Secondary Payer Act (MSPA) governs how payments for future medical services are handled when a third party makes a financial settlement for future medical expenses to an individual who is or will soon be covered by Medicare. The MSPA mandates that all parties involved in the financial settlement must protect Medicare's interests when settling a claim. The recommended method to protect Medicare's interests is a Medicare Set-Aside (MSA) Account, an interest bearing bank account into which the settlement monies are deposited. Currently, over $4 billion in annual MSA payments made to individuals in the U.S. Typically, an insurance carrier, self-insured employer, or perhaps a Medicare compliance company will settle with the individual for payment in the form of a lump sum or, more frequently, in the form of a combination of an annual annuity and cash payment for a seed amount. The average life of such an annuity is 26 years. The average first year payment for Medicare eligible expenses is often around $20,000, with subsequent annual payments averaging $5600 per year. In other situations, fifty percent of recipients receive an unrestricted settlement that averages $10,000 per year for the life of the settlement.

Under the MSPA, if funds are obtained in a settlement for an individual's future medical services, these funds must be “set aside” and used to pay for the future medical services that might otherwise fall on Medicare to pay. If this does not occur, the beneficiary may risk losing access to future Medicare benefits. Therefore, an insurance carrier or self-insured employer must allocate a portion of the settlement amount to set aside to ensure that Medicare's interests are protected. The allocation/settlement process is typically handled by a team of lawyers, adjusters, physicians, and other medical professionals employed by the carrier. The aforementioned team will evaluate the individual's injury and determine the types of medical services that will likely be needed to treat such an injury, the life expectancy of the beneficiary, and the future costs that will likely be incurred. The team will also evaluate and estimate which medical treatments and prescriptions (and qualified costs associated therewith) would ordinarily be covered by Medicare if it were the primary insurer of the individual.

That portion of the settlement that is allocated as costs and that would ordinarily be paid by Medicare must be set aside the MSA account. The Medicare set aside funds must be deposited in an interest-bearing account and can only be used for Medicare-eligible expenses via providers (e.g., doctors and hospitals) and pharmacies. In a typical payment scenario, an individual receives medical services from a provider or pharmacy. The provider or pharmacy will check the service codes against a number of state and federal tables that indicate whether Medicare would pay for the service and how much the service costs. If the service and amount are approved, payment may legitimately be made from the MSA account. It is only after the funds from the MSA account are properly exhausted that Medicare/Medicaid will pay for any remaining medical expenses. If the funds from the MSA account are misspent by paying non-Medicare rates for medical services and/or pharmaceuticals, or even paying for items entirely unrelated to the injury, then the settlement beneficiary can risk loss of Medicare eligibility for services related to their injury.

The recipient of the medical services (or a designated administrator) must submit an annual report to the Centers for Medicare and Medicaid Services (“CMS”), the federal agency tasked with administering the Medicare program. The annual report must show, among other things, the amount and nature of actual expenditures from the account, and attest that the medical expenses were paid according to CMS guidelines. Because of the complexity of the process by which settlement funds must be set aside and used, and the annual reporting requirements to CMS, many individuals choose to utilize a professional administrator of an MSA account and/or a third-party solution that assists them in self-administering their own MSA account, rather than risk running afoul of CMS regulations. Accordingly, what is needed in the art are systems and related methods for the creation and administration of accounts and payments provided under the Medicare Secondary Payer Act that do not suffer from the deficiencies of the prior art.

### SUMMARY

Disclosed herein are systems and related methods for administering a financial account on behalf of a system member, where payments from the financial account are restricted to only eligible expenses. Such administration of a restricted-use financial account assists members in properly expending funds from their financial account, and thus maintaining compliance with any guidelines or laws regulating the expenditure of funds from their account.

In one embodiment, a method of administering a restricted-use financial account may comprise receiving personal information regarding a user, where the personal information includes a personal status of the user. Such a method may then comprise creating or facilitating the creation of a restricted-use financial account based on the received personal information, where the portion of the personal information regarding the personal status of the user is used in determining the restrictions to be placed on expenditures paid from the financial account. The method may then include facilitating the funding of the financial account with funds obligated to, or otherwise for use by, the user based on the personal status of the user, and issuing, authorizing, or associating a payment vehicle associated with the financial account for use by the user for payment of eligible expenses from the financial account. The exemplary method may also include receiving a payment request from a provider of goods or services to be provided for the benefit of the user, and then determining if the goods or services related to the payment request is an eligible expense payable from the financial account. Next the method could include authorizing payment for the eligible expense to the provider from the financial account.

In another embodiment, a system for administering a restricted-use financial account is provided. Such an exemplary system may comprise a user interface for receiving personal information regarding a user, where the personal information includes a personal status of the user, and a database for storing the received personal information. Such a system may also comprise a computer platform having a restricted-use financial account associated with the database and created based on the received personal information, where the portion of the personal information regarding the personal status of the user is used to established restrictions on expenditures payable from the financial account. Alternatively, the computer platform may instead facilitate the creation of the restricted-use financial account elsewhere, for example, with a payment vehicle processor, wherein the computer platform at least in part determines eligible expenses from the account. In addition, funds obligated to, or otherwise for use by, the user based on the personal status of the user may be placed in the financial account. An exemplary system may also include a provider interface for receiving a payment request from a provider of goods or services to be provided for the benefit of the user. In advantageous embodiments, an exemplary computer platform may be configured to (1) associate a payment vehicle(s) with the financial account for use by the user for payment of eligible expenses from the financial account; (2) determine if the goods or services related to the payment request is an eligible expense payable from the financial account, and (3) authorize payment for the eligible expense to the provider from the financial account.

In a more specific aspect, the disclosed principles provide a solution for Medicare Set Aside (MSA) account payments by which individuals may self-administer one or more MSA accounts on their own behalf, yet ensure compliance with the guidelines and laws governing such MSA accounts, such as CMS. For example, methods of administering a Medicare Set Aside (MSA) account are disclosed herein. In one embodiment, such a method may comprise receiving personal information regarding a user, where the personal information includes information on an injury of the user. Such a method may then include creating, or facilitating the creation of, an MSA account based on the received personal information, and funding, or facilitating the funding by a third party of, the MSA account with funds obligated to, or otherwise for use by, the user based on the injury of the user. An exemplary method may further include associating a payment vehicle with the MSA account for use by the user for payment of eligible medical expenses from the MSA account.

In addition, a payment request may be received from a medical provider of goods or services to be provided for treatment of the user's injury. The method may then determine if the goods or services related to the payment request is a Medicare-eligible medical expense and related to the injury for which the financial settlement was made, and therefore payable from the MSA account. Additionally, the method may determine if the payment request amount for a Medicare-eligible expense should be adjusted, and if so, adjusting the payment amount based on the determination. In this respect, the method may determine if the payment amount requested is the usual and customary costs for the goods or services. For example, the usual and customary costs for the goods or services may be adjusted based on geographic location of where the goods or services are to be provided to the user or where the user sustained the injury. Moreover, the usual and customary costs for the goods or services may be adjusted based on a determined Preferred Provider Organization (PPO) cost for the goods or services. Then, an exemplary method may comprise authorizing payment, in either the original or adjusted amount if it has been adjusted, for the eligible medical expense to the medical provider from the MSA account.

### BRIEF DESCRIPTION OF THE DRAWINGS

Embodiments are illustrated by way of example in the accompanying figures, in which like reference numbers indicate similar parts, and in which:

FIG. 1 illustrates one embodiment of a simplified block diagram of one embodiment of an MSA system in accordance with the disclosed principles;

FIG. 2 illustrates one embodiment of a detailed diagram of both the enrollment process and usage of an MSA system established in accordance with the disclosed principles;

FIG. 3 illustrates one embodiment of a block diagram for a card services platform for use with a system or process implemented in accordance with the disclosed principles;

FIG. 4 illustrates one embodiment of a flow diagram setting forth a general view of one embodiment of the enrollment process for an MSA platform established in accordance with the disclosed principles;

FIG. 5 illustrates one embodiment of a flow diagram of an exemplary embodiment of a process for accessing a Member Portal within an MSA platform implemented in accordance with the disclosed principles;

FIGS. 6A and 6B illustrate one embodiment of a flow diagram of an exemplary process for an enrolled healthcare provider seeking payment from the MSA account of a member of the disclosed MSA platform;

FIG. 7 illustrates one embodiment of a flow diagram for an exemplary adjudication process conducted with the disclosed MSA platform and in accordance with the disclosed principles; and

FIG. 8 illustrates one embodiment of a block diagram for an Administration Portal for use with an MSA solution system or process implemented in accordance with the disclosed principles.

### DETAILED DESCRIPTION

The disclosed principles provide a solution for Medicare set aside (MSA) account payment systems and related methods by which individuals may self-administer one or more MSA accounts on their own behalf. An MSA platform in accordance with the disclosed principles ensures that all expenses paid from the MSA account are paid in accordance with CMS guidelines and compensable to the injury. A number of payment strategies to facilitate payments may be implemented by an adjudication engine implemented with the disclosed MSA platform to ensure such CMS compliance. The disclosed MSA solution provides a unique end-to-end automated solution that facilitates a number of functions. Such functions include, but are not limited to, end-to-end administration tools, self-enrollments by MSA account holders and enrollments via third-parties such as insurance carriers, secure loading of MSA settlement dollars, and an adjudication engine to ensure all medical services, devices, equipment and prescriptions are Medicare eligible expenses and authorized and priced according to CMS guidelines, multiple payment solutions to facilitate CMS compliant payments to healthcare providers and pharmacies, state specific and usual & customary fee schedule discounts/cost savings, and even additional cost savings solutions, such as access to Preferred Provider Organization (PPO) and Pharmacy Benefits Manager (PBM) networks, to further protect the fiduciary interests of Medicare.

An MSA platform implemented in accordance with the disclosed principles also offers tools that enable a number of administrative functions. These may include, but are not limited to, secure login, as well as various levels of access, for MSA platform administrators, reporting for all aspects of the MSA platform business, manual review of payment requests, and the ability to manage clients, members, enrollments, and providers. Additionally, the disclosed MSA solution provides client, member and provider interface tools, for example, via a web portal for each party. Accordingly, clients may access a Client Portal for client setup and registration, access administration rights, provide client enrollment of members, and access to client payment tools. Members, who are the MSA account holders, may utilize a Member Portal for account access, transaction history and reporting, self-enrollment, including funds transfer from another bank account to an MSA payment card account, or other payment vehicle, established via the MSA platform, member payment tools, member card activation, member document storage, and annual reporting of MSA account activity, for example, an annual CMS compliance report to maintain Medicare eligibility. For example, the member may be able to self-file the required annual CMS compliance report for MSA accounts, and that filing could be manually or automated by the disclosed MSA platform. For healthcare providers, they may access the MSA platform via a Provider Portal for provider account setup and registration, access administration rights, location setup, patient (i.e., member) payment authorization portal, patient payment/treatment history, pre- and post-authorization payment requests, and payment history. Of course, other useful features, which fall within the broad scope of the present disclosure, may also be provided via the disclosed MSA platform.

### Exemplary MSA Platform

An MSA account solution constructed in accordance with the disclosed principles provides a compliance mechanism, for example, compliance with CMS guidelines, for members' MSA accounts before funds are actually disbursed from those accounts. The MSA platform uses the patient enrollment information to create a member profile with their MSA account, as well as a payment vehicle such as a payment card, such as a debit card, prepaid card, credit card, mobile wallet payment system, or any other type of payment vehicle, to make payments from their MSA accounts. The MSA platform may also create a patient pharmaceutical profile that either the MSA platform or a partner PBM will use to adjudicate prescriptions presented by the member. The MSA solution for prescription fulfillment is particularly unique because it enables the MSA platform or the PBM to adjudicate payments and/or charge the MSA account member in a “card-not-present” scenario. And it changes the payment flow to the pharmacy because the MSA platform or the PBM, not pharmacy, receives the member's funds and then pays the pharmacy.

For typical medical services and equipment, as well as pharmaceuticals, the collection of enrollment data and member specific information drives the adjudication engine of the MSA platform in order to facilitate the proper payment of MSA account-eligible expenses. The disclosed adjudication process determines if a medical expense is compensable to the injury, re-prices according to CMS guidelines, looks for state specific fee schedule pricing, and also accesses PPO networks that may offer additional savings to the member. In addition, the correct fee schedules are determined by the state of jurisdiction (for example, where the injury occurred) and the adjudication engine could include the ability to check for correct pricing based on whether the applicable state is a single zone or multi-zone state. The MSA platform may also utilize both In-Network and Out-of-Network providers and facilities to settle transactions. The disclosed MSA solution performs the adjudication and then communicates with the payment card processor before or after the card swipe, to instruct the processor how to authorize a transaction. Moreover, the disclosed MSA solution can use Merchant Category Codes (MCCs) to automatically block transactions submitted by non-healthcare providers.

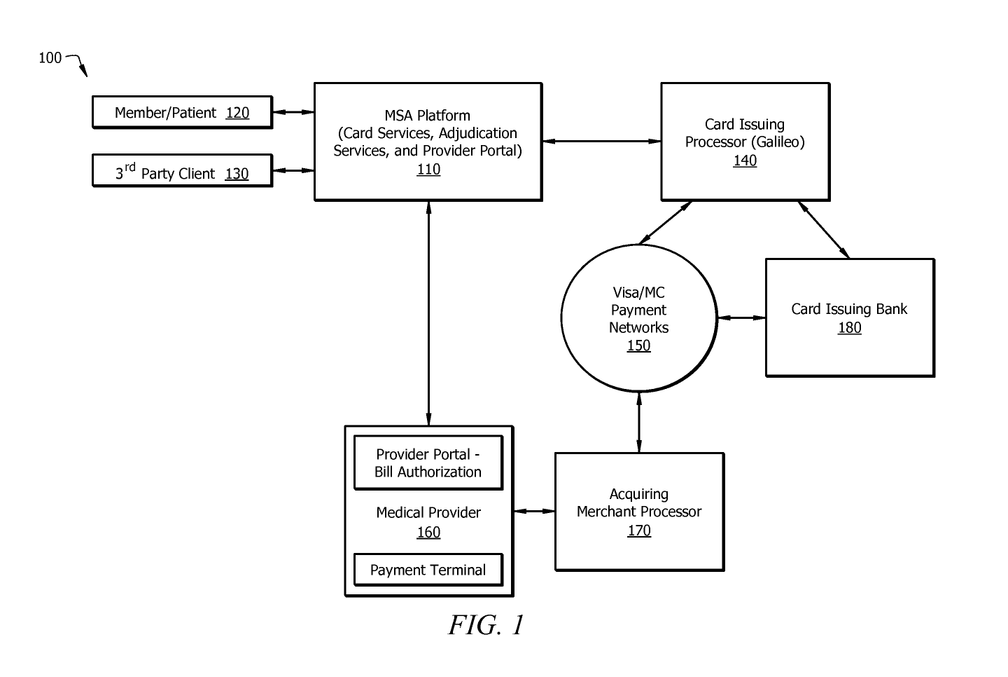

FIG. 1 illustrates a simplified block diagram of one embodiment of an MSA system 100 in accordance with the disclosed principles. FIG. 1 illustrates an MSA platform 110 and its connections with patients, third party vendors, clients, providers, and financial institutions. More specifically, members/patients 120 may enroll with the MSA platform 110 either themselves or via a third party client 130. The enrollment process is discussed in greater detail below. Once enrolled, a card issuer 140 issues an MSA payment vehicle (for example, any type of payment card) for use with the disclosed MSA platform 110, and such an MSA payment vehicle may be affiliated with a payment network 150, such as VISA® or MasterCard®, for easy use at the wide networks available with such payment networks. The MSA account card is issued by a card issuing bank, where the funds for the MSA account may actually be kept and tracked.

The disclosed MSA system 100 also provides a Provider Portal for use by medical providers 160 that provide medical services to members of the MSA system 100. The Provider Portal performs the adjudication for the payment of the medical services, and communicates with a processor 170, before or after the card swipe by the member at the medical provider's point-of-sale payment terminal, in order to authorize a transaction. The MSA adjudication process determines that a medical expense is compensable to the injury, re-prices according to CMS guidelines if needed, looks up state specific fee schedule pricing, and also accesses PPO (or similar) networks that may offer additional savings to the cardholder/member. Once a transaction is authorized, and the amount of the transaction properly established, the card issuing bank 180, via the card issuing processor, settles funds through the payment networks to the provider's merchant account. The adjudication process and the specific operation of the provider portal are both described in additional detail below.

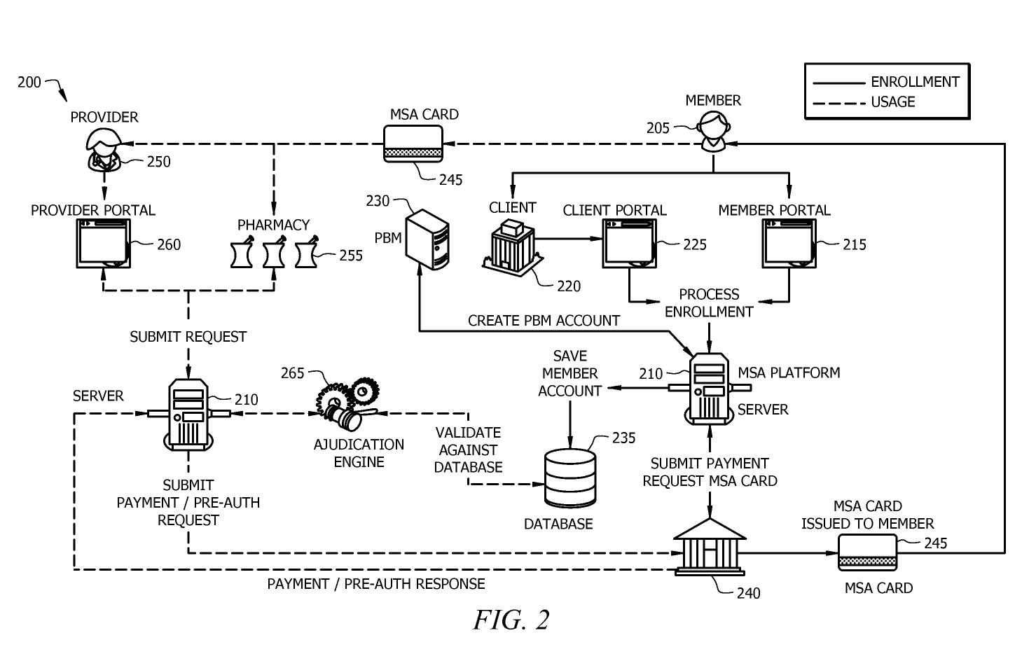

Turning now to FIG. 2, illustrated is a more detailed diagram of both the enrollment process and usage of an MSA system 200 established in accordance with the disclosed principles. A member/patient 205 of the MSA system 200 enrolls with the MSA platform 210 either directly via a Member Portal 215, or via a client 220 which accesses the MSA platform 210 via a Client Portal 225. In addition, when the member's profile is created, the MSA platform may also create a pharmacy profile, which may include information regarding a Pharmacy Benefits Manager (PBM) 230. Once enrolled, the member's 205 account information is stored in a database 235 associated with and accessible by the MSA platform 210. Additionally, the member's MSA account is then funded, typically by a third party such as an insurance carrier or an annuity company. As mentioned above, a card issuing bank 240 issues the MSA account card 245 for each member's MSA account for use by the member for approved MSA transaction within the system 200.

Continuing with FIG. 2, the use of an issued MSA account payment vehicle/card 245 by a member 205 is also illustrated. Specifically, the member 205 presents the MSA account card 245 to a medical provider 250 or pharmacy 255 for services or pharmaceuticals covered under the MSA system 200. At the time the medical services or pharmaceuticals are requested, the medical services provider 250 accesses the MSA platform 210 via a Provider Portal 260 and a server associated with the MSA platform 210. Likewise, if the expense sought by the member 205 is for pharmaceuticals, the pharmacy 255 also communicates with the MSA system 210 in order to authorize the transaction.

Once the MSA platform 210 is accessed for authorization of the transaction, the MSA platform 210 employs an adjudication engine 265 to authorize the transaction. More specifically, the adjudication engine 265 will not only validate the member information and type of service, equipment or medication sought by the member 205 against the database 235, but the adjudication engine 265 can also adjust pricing according to CMS or other appropriate guidelines if needed, as well as match state specific fee schedule pricing and access preferred provider networks that may offer additional savings to the member 205. Once the transaction for medical services or medications has been authorized in whole or in part by the MSA platform, the provider is authorized to charge the payment card (or other vehicle) using their merchant services account, and the payment authorization is submitted by the MSA platform 210 to the card issuing processor 240. The payment authorization may include a specific authorized transaction amount or a range of authorized transaction amounts, and an authorization time frame. When the card issuing processor 240 receives the payment request from the provider 250, via the payment networks, the card issuing processor 240 will ensure the request has been submitted from an authorized MCC code, for the approved amount or range of amounts, and within the approved time frame. If these conditions are met, then the card issuing processor 240 will approve the transaction and settle funds to the provider's 250 merchant account. Alternatively, the medical provider 250 can first “pre-authorize” the member's payment card for an estimated amount for the medical services or prescriptions, but the MSA platform will not instruct the card issuing processor 240 to settle funds to the provider 250 until all medical and pharmaceutical services have been submitted and authorized by the MSA platform.

### Card Services Platform

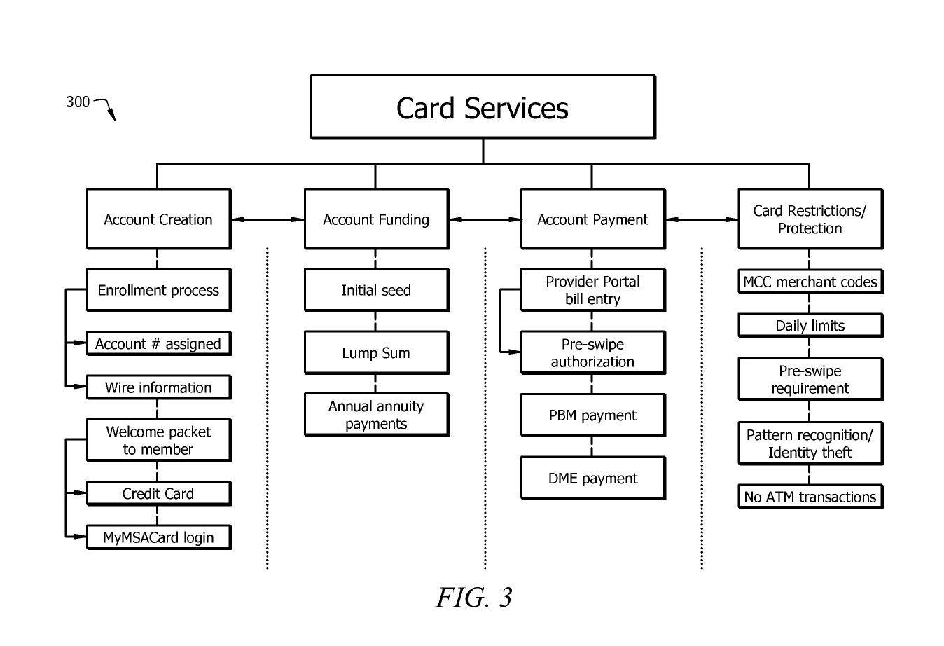

Looking now at FIG. 3, illustrated is a block diagram for a card services platform 300 for use with a system or process implemented in accordance with the disclosed principles. The card services platform 300 provides the backbone network to administrating payments from member MSA accounts to service providers, hospitals, suppliers and pharmacies, just to name a few examples of potential system participants. Payment via a system or process implemented in accordance with the disclosed principles is immediate and can occur at the point of sale. Additionally, as discussed further below, payment may also be made as a “card-not-present” transaction. The card services platform 300 can work with multiple processors, payment card (or other payment vehicles) providers and banks or other financial institutions.

MSA account creation, funding, payment, and card restrictions and protections are all facilitated by the card services platform 300. With account creation, an MSA member's account is created after successful enrollment. For funding the new member's MSA account, account details are transmitted via the card platform for initial funding instructions and future annuity payments, if applicable. As illustrated, the MSA account can be funded by a lump sum, or by an initial seed and also with the annual payment(s) if an annuity is part of the settlement for the member. Once enrolled, a welcome packet containing the MSA account payment system, benefit explanation, secure login information and important contact information may be sent to the newly enrolled member. It should be noted that although the term “card” is used throughout this disclosure, it should be understood that the disclosed principles are not limited to payment systems based only on a card, and instead cover all forms of payment or payment vehicles useable by a patient to pay for eligible services, equipment or pharmaceuticals. For example, vouchers (paper or electronic), checks, near-field payment systems, mobile device-based payment systems, or online-based payment systems also fall within the scope of coverage of the disclosed principles.

The card services platform 300 also facilitates the use of the MSA account card or other MSA account payment vehicle. Payments from the MSA account will be made directly to healthcare providers, such as doctors and other qualified practitioner, as well as qualified medical facilities, or a PBM if one is employed. Healthcare providers may use the Provider Portal (discussed in further detail below) to access the disclosed MSA Platform to bill for a patient's treatment, or may even access the MSA platform for a pre-swipe authorization before providing their medical service to the patient. Some transactions may be processed without the Provider Portal prerequisite, such as the aforementioned PBM payments. Those types of transactions may be handled via a backend process, and in such embodiments no payment card swipe, or similar point-of-sale payment vehicle, would be necessary before payment is authorized.

For all payment vehicles employed with the disclosed principles, an MSA account is designed to have restrictions on where the card can be used, what it may be used for, and how much money is allowed to be paid. MSA funds are set aside for future medical expenses and therefore the MSA account can only be used for approved expenses. Thus, restrictions and account protections can be provided by the card services platform 300. In the case of a network payment card, the card may be restricted by, for example, MCC merchant codes. In addition, limits, such as daily limits, etc. can be applied to the member's MSA account. Also, pre-swipe requirements may be employed. Specifically, providers or pharmacies may be required first pre-authorize expenses to be paid from the MSA account. For security, the MSA account card may employ typical security features currently employed for credit cards and the like, such as pattern recognition and identity theft technologies. Also, while most conventional credit, debit, or other payment cards may be used for cash transactions at ATMs, a payment card issued in accordance with the disclosed principles could be precluded from use at ATMs or other cash-based transactions in order to help ensure that MSA account funds are used only for approved expenses.

### Enrollment Process

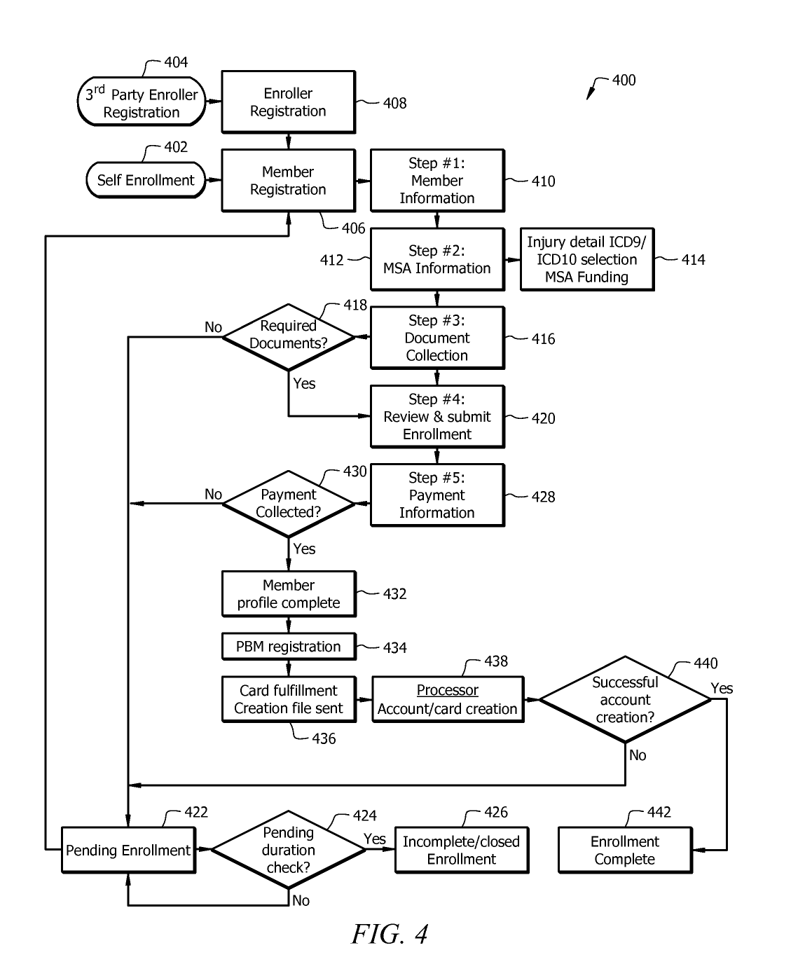

Looking now at FIG. 4, illustrated is a flow diagram setting forth a general view of one embodiment of the enrollment process for an MSA platform established in accordance with the disclosed principles. In order to initially set up an MSA account for self-administration (or by a professional/third party administrator), individual members must first be enrolled, for example, via a website portal provided in connection with the disclosed MSA platform. More specifically, at a step 402, individual members may self-enroll via a member registration page 406, typically accessed via a web portal, provided specifically to such individual members. Alternatively, at step 404, third party clients, such as an insurance carrier, may enroll individual members via a separate client portal, at step 408. Most enrollments may be initiated during the settlement negotiation process by the third party entity who is handling the case for the member. A single third party entity may manage multiple enrollments at the same time by utilizing the client portal to manage the registration process.

The enrollment process generally requires the entry of information concerning the identity of the member at (step 410), information regarding the MSA account (step 412), which includes information regarding his or her injury(ies) (step 414), and any necessary documents relevant to the MSA account (step 416). More specifically, such information would include, but is not limited to, the member's full name, date of birth, social security number, gender, and contact information. The enrollment process may also include the entry of information relating to the member's particular injury(ies), such as by providing ICD9/ICD10 codes, a description of the injury(ies), and the date and location of the injury. Additionally, the member will be required to enter his Medicare/Medicaid information during the enrollment process so that the MSA platform can properly administer the member's MSA funds in accordance with CMS guidelines.

At this point in the enrollment process, if all the required documents have been submitted, at the decision step 418, the process moves on to the review and submit documents step 420. However, if at the decision step 418 it is determined that not all the required documentation has been provided, the enrollment process is halted at step 422. If at a decision step 424 it is determined that a predetermined amount of time has expired, the enrollment process is marked as incomplete and the process for that member is closed, at a step 426. If the predetermined time limit has not expired, the process may loop back to step 422, where the enrollment process for that member remains pending.

When all of the required documents have been provided, as determined at step 418, the documents and other required information are reviewed and submitted at step 420. During the enrollment process, required documents are typically uploaded for verification and stored in a file/document vault on behalf of the member. Then, at step 428 the member's MSA account payment information is entered into the disclosed MSA platform. This information would include the type and amount of settlement received by the member, as well as the payment structure to be received by the member. Next, at step 430, it is determined if payment under the settlement has actually been made to the MSA account administered by the disclosed MSA solution. If not, the enrollment process again remains in the pending stage (step 422) until payment is collected, or becomes incomplete/closed (step 426) if payment is not collected within a predetermined amount of time. If payment has been collected, then the process moves on to step 432, where the enrollment process is marked as completed. Alternatively, the MSA platform may proceed with having a payment card issued to a new member before settlement funds have been received, if desired. In such embodiments, once the member's personal and settlement/annuity information is collected and verified, and payment card for the MSA account may be issued and account information provided to the funding party for later deposit of the funds. Next, at step 434, PBM registration is completed, if a PBM will be part of the payment administration provided by the MSA platform. Upon successful member profile creation and payment, the enrollment process assigns a unique member identification number to the enrollee and may pass the information on to the PBM vendor for pharmacy account creation.

Once the PBM registration, if any, is completed, the enrollment process moves on to step 436 where a file containing the member's MSA account information, etc. may be sent to a card issuing processor (or process for other type of payment vehicle). At step 438, the card issuing processor creates an account and affiliated payment vehicle (e.g., a “pre-paid” payment card or other funded payment vehicle) in the MSA member's name. As mentioned above, a payment card may be issued prior to funding the account, if desired, with the account information sent to the funding party for later deposit of funds. At a step 440, it is determined whether a complete account and card has been created by the card issuing processor. If not, the enrollment process again remains in the pending stage (step 422) until the card account is created, or becomes incomplete/closed (step 426) if the card account is not created within a predetermined amount of time. If the card creation process is completed, the enrollment process moves to an end step 442 where the enrollment process is complete.

### Member Portal

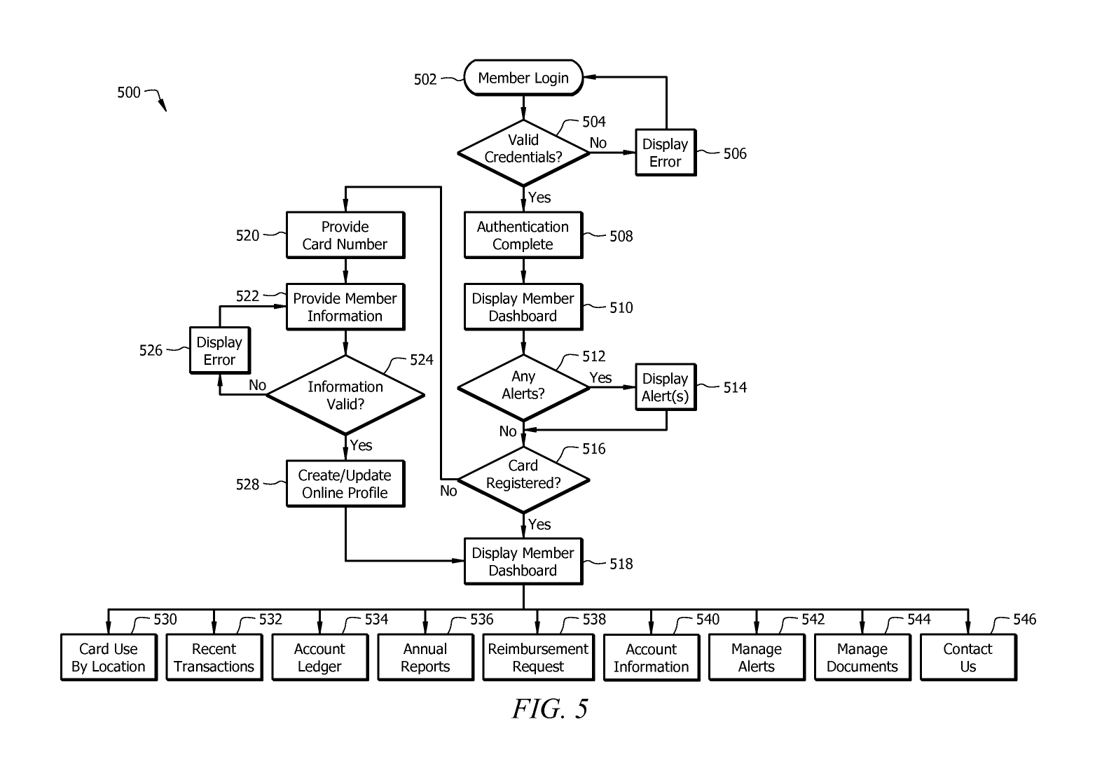

Turning now to FIG. 5, illustrated is a flow diagram 500 of an exemplary embodiment of a process for accessing a Member Portal within an MSA platform implemented in accordance with the disclosed principles. The Member Portal facilitates the use of the MSA account administered by the disclosed MSA platform by allowing members to self-monitor their MSA spending through the use of online monitoring tools, alerts and electronic reimbursement requests. The Member Portal may also provide prospective MSA Members the opportunity to self-enroll for the MSA platform. The homepage of the Member Portal provides options for existing MSA Members to login using their Username and Password, to allow newly registered members to link their MSA account card or other payment vehicle issued using the disclosed MSA platform to an online profile. The homepage may also include an “Enroll Today” option for prospective MSA members to enroll into the MSA platform.

To access their accounts, members first login to the Member Portal, at a start step 502. The credentials entered by the member may then be verified at step 504, and if they are not verified, a display error may be display to the member as step 506. If the member's login credentials are verified, the authentication process is complete at step 508, and the Member Dashboard, or other user interface, may be displayed to the member at step 510. At this point in the process, it may be determined if alerts are pending for the member at step 512, and if so, those alerts may be displayed to the member at step 514. If no alerts are pending for the member, the process may then determine if the member's MSA account card has been registered with his or her online MSA account. If the member's card has already been registered, then the Member Dashboard is displayed to the member, as shown in step 518.

However, if it is determined that the member's card has not yet been registered with the member's online profile, for example, if the member was enrolled via a third party as described above, the member may then be prompted to provide the MSA account card number, as shown in step 520. Next, the member may be prompted to provide his member information at step 522, for example, his unique ID number, MSA account information, member password or other identifying information, so that the MSA platform can ensure that entered card information is matched with the correct member. Next, it is determined if the information prompted for and entered by the member is valid at step 524. If the information is determined not to be valid, an error message may be displayed to the member at step 526, and the process returned to the steps for entering the member's information. If the information is determined to be valid at step 524, the process may then create or update the member's online profile with the member's MSA account card information.

Once the member's MSA account card (or other payment vehicle) information has been linked with the member's online profile, the Member Dashboard may again be displayed to the member, as in step 518. Through the Dashboard or other similar interface, the member may then be able to access information on his MSA account. Specifically, the member may access a Card Use by Location area (530). Such an area may show a high-level view of the member's MSA account card usage by dollar allocation percentage across the four major bill type segments: Provider Office, Pharmacy, Hospital, and Other. The member may also access a Recent Transactions area (532), which may shows a summary of, for example, the 3 most recent successful processed payments made from the MSA account card account.

The Dashboard may also allow the member to access an Account Ledger area (534), which may provide access to historical account information on payments that have been processed for the MSA account member. The Account Ledger may provide filters to query the account history activity of the member's Member Profile by Begin and End Date Interval. Search results could be shown in a tabular summary format, where clicking on an individual row will show the Transaction History Detail for the selected item. Additionally, the Account Ledger “Detailed History” view may provide detailed information on a processed payment transaction for the activity of an MSA account member. Attributes of the Transaction Detailed History may include the following items. Of course, other or lesser detail for such a transaction may also be displayed, as needed.
Transaction ID
Date of Service
Billing Agency Name (if 3^{rd} Party Biller)
Description of Service
Location of Service (Name)
Billing Agency Tax ID (if 3^{rd} Party Biller)
Amount of Service
Provider of Service (Name)
Savings (dollar amount and %)
Provider Tax ID
Type of Service
Location Tax ID
MSA Billed Procedures, with Code, Description, Amount, Original Price and Discounted Amount
Medicare Billed Items, with Code, Description, Amount, Original Price, Discounted Amount and Reason Not Covered Code
Client Liability Items, with Code, Description, Amount, Original Price, Discounted Amount and Reason Not Covered Code

Other areas provided to the member via the Dashboard may also include an Annual Reports area (536), where MSA account members may access and download their MSA account transactions for account review and tax filing purposes, or for other needs. For example, the member may be able to self-file the required annual CMS compliance report for MSA accounts, and that filing could be manually or automated by the MSA platform. MSA Members may also submit manual reimbursement requests via a Reimbursement Request area (538) for any transactions for which they were not able to use their MSA account card at the time of payment. For example, this can occur if the merchant/provider is not participating in the MSA account card program for electronic payment capture. The MSA Member may submit a request for reimbursement by supplying copies of receipts and other supporting documentation with a description of the transaction and the amount to be reimbursed. Reimbursement requests may then be reviewed to determine if reimbursement from the MSA account is valid.

Members may also access an Account Information area (540) via the Dashboard.

The Account Information area allows members to manage details of their Member Profile.

Specifically, members may update:
Contact Address
Contact Phone
Contact Email
Username
Password
Contact Preferences
   Of course other information may also be updated, if needed. Members may also manage their alerts via a Manage Alerts area (542). Such alerts may include, but are not limited to, low MSA account funds, certain reports are now available to be viewed/downloaded, or upcoming expiration of an MSA payment card or other payment vehicle. Members may also access a complete archive of received account alerts and other notifications by viewing the Manage Alerts page. Also, members may be prompted to set up their own alerts, if needed.

The Dashboard may also allow members to access a Manage Documents area (544). In this area, members may manage the documents which they submitted in support of their MSA account enrollment, and use the MSA Member Portal to centralize the management of any other documents related to their claim by adding them via the Manage Documents feature. Finally, the Dashboard may provide a Contact Us area (546) where members may obtain contact information to contact administrators of the disclosed MSA platform for help using the Dashboard of perhaps for MSA account help in general. Although only certain pages are illustrated in the embodiment of FIG. 5, it should be understood that other or different pages may also be provided for access by the member, and the disclosed principles are not limited to any particular access pages.

### Provider Portal

The disclosed MSA solution also provides a Provider Portal that facilitates the use of the MSA account by allowing healthcare providers to accept and manage payments from MSA account members. This may be provided as part of the MSA platform via a secure, web-based interface. The homepage of such a Provider Portal may provide options for existing Provider Profiles to login using their username and password, and to allow prospective providers an option to enroll for a new Provider Profile via an “Enroll Today” option. Moreover, prospective healthcare provider enrollees may access a Payee Enrollment Process to complete an online enrollment form to create their Provider Profile. The Payee Enrollment Process would distinguish between Provider 1st party and 3^{rd} Party billing agency enrollments. A Provider Portal dashboard may be displayed after a provider has successfully authenticated to the MSA Provider Portal interface. The Dashboard may display a number of accessible pages, similar to the member Dashboard described. For example, the Provider Dashboard may display links for areas such as Recent Transactions, Account Information and Payments by Location, which may aggregate the successful payment amounts of the top locations from an all-time historical view.

Another area of the Provider Portal may be a Transaction History page, which may allow providers to access historical account information on payments they have accepted from members. This page may provide filters to query the payment history activity of the Provider Profile using one or more criteria, such as Tax ID number, Provider name, Begin and End Date interval, National Provider Identifier (NPI) number, location and amount Minimum/Maximum. Of course, other search criteria may also be available for use. Search results may be shown in a tabular summary format. Clicking on an individual row could show the Transaction History Detail for the selected item. The Transaction History Detail view may provide detailed information on a processed payment transaction for the activity of a member with the searching provider. Exemplary details that may be provided include, but are not limited to, the following. Of course, other or different attributes may also be provided in the Transaction History Detail view.
Transaction ID
Date of Service
Billing Agency Name (if 3^{rd} Party Biller)
Description of Service
Location of Service (name)
Billing Agency Tax ID (if 3^{rd} Party Biller)
Amount of service
Provider (Name)
Savings (Dollar Amount and %)
Provider Tax ID
Type of Service
Location Tax ID
MSA Billed Procedures, with Code, Description, Amount, Original Price and Discounted Amount
Medicare Billed Items, with Code, Description, Amount, Original Price, Discounted Amount and Reason Not Covered Code
Client Liability Items, with Code, Description, Amount, Original Price, Discounted Amount and Reason Not Covered Code

Another area of the Provider Portal may be a Provider Profile page. The Provider Profile view may allow providers to manage details of their Provider Profile account with the disclosed MSA platform. For example, providers may update one or more of the following; however, other items may also be displayed and updated through the Provider Profile page.
Company Name
Biller Tax ID
Contact Name
Title
Phone
Contact Email
Contact Address
Contact Address 2
Contact City
Contact State
Contact ZIP Code
Provider Phone
Contact Fax
Username
Password

### Payment Presentment

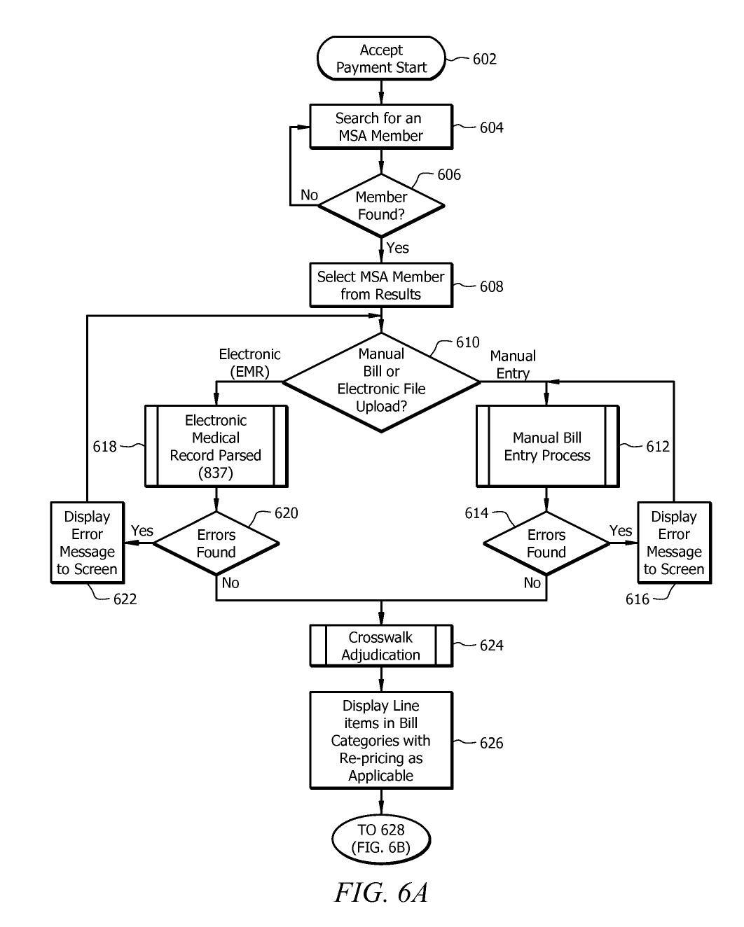

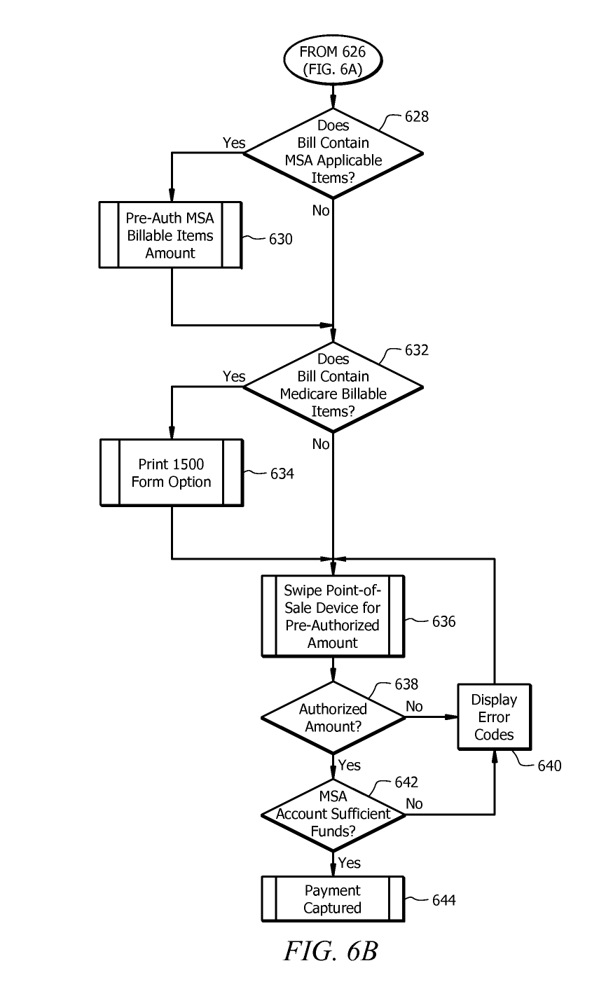

Another area of the Provider Portal accessible by enrolled providers may be an Accept Payment area where providers can submit payment requests for their services, etc. provided to members. FIGS. 6A and 6B illustrate a flow diagram 600 of an exemplary process for an enrolled healthcare provider seeking payment from the MSA account of a member of the disclosed MSA platform. One of the primary functions of the Provider Portal is to allow the creation of online billing requests for MSA account members receiving services from participating providers. The billing requests typically include all the services rendered for a member by the provider and/or the provider's facility. The Accept Payment process, in conjunction with the MSA platform's adjudication process and associated logic (a.k.a. “Crosswalk”) allow the determination of covered services, identification of non-covered procedures, and re-pricing of items on a member's service statement.

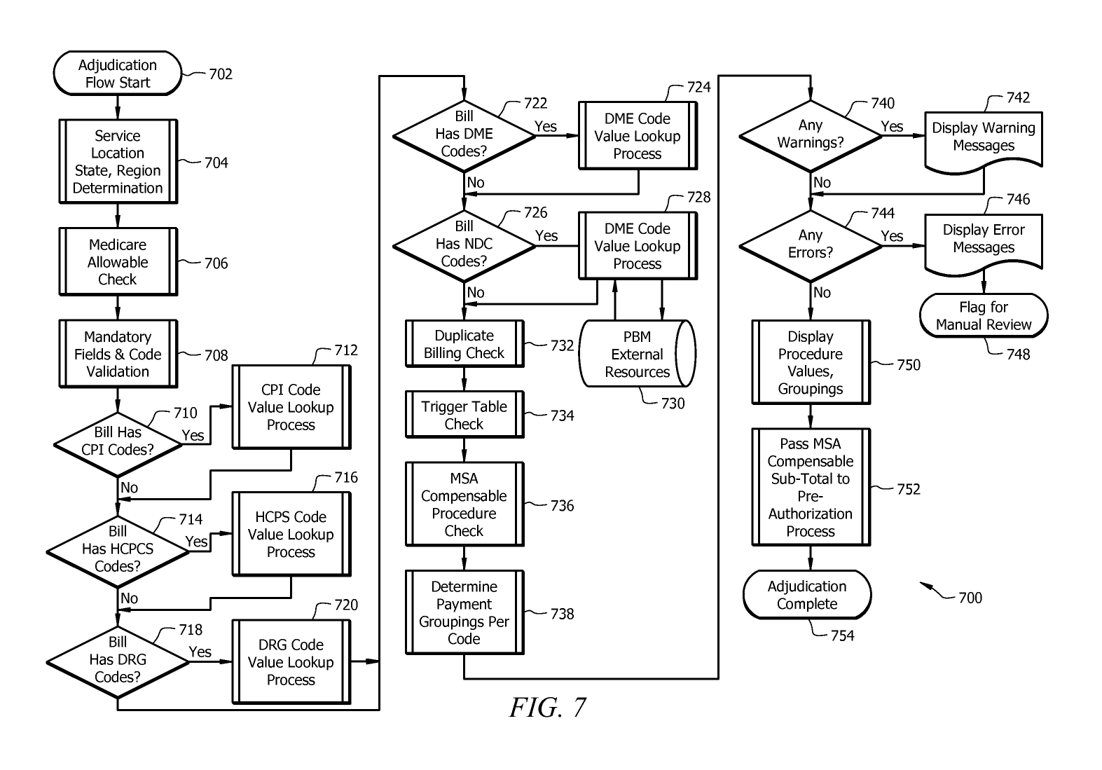

Payments requested and made through the disclosed MSA solution may be in more than one manner. Medical providers may elect a “pre-swipe authorization” for authorizing payment for their services to a member. For example, a medical provider may submit billing information for adjudication, which is discussed in detail with reference to FIG. 7. The MSA platform's adjudication engine (also described below) utilizes the member profile information and the information regarding the healthcare service from the provider to determine which medical services are approved. The system will return a response to the medical provider indicating which services are authorized or declined for payment, as well as an indication of whether sufficient funds are available from the member's MSA payment account. When the medical provider confirms what they will charge the member account for eligible expenses, a payment authorization is transmitted to the card (or other payment vehicle) issuing processor authorizing a specific dollar amount or an amount range, and perhaps even a time period in which a transaction may be approved. The medical provider can then run a card transaction through their merchant services account and receive payment. The funds will be deducted from the member's payment account by the card issuing processor and settled back through the payment network to the provider's bank account.

Medical provides may alternatively elect a “post-swipe authorization” for payment of their services. In this scenario the medical provider will charge the member's card or other payment vehicle first. This type of transaction is called a “pre-authorization”, which is different from the above-described “pre-swipe authorization.” A pre-authorization is a merchant services transaction where a merchant confirms funds are available and held for the merchant (i.e., provider). The provider later sends a request to “settle” the transaction and receive payment. The settled transaction may be less than, the same or greater than the original pre-authorized amount. After the medical provider has pre-authorized the funds on the issued card, the medical provider will later submit billing information, and the adjudication engine utilizes the member profile information to determine which medical services are approved. The system will return a response to the medical provider indicating which services are authorized or declined for payment, as well as an indication of whether sufficient funds are available from the member's MSA payment account. If funds are available, then the MSA platform will instruct the card issuing processor to settle the correct, adjudicated amount back to the provider. In both “pre-swipe” and “post-swipe” processes, the MSA platform can recognize large bills, for example, those submitted from hospitals, and those bills can be flagged for manual review and negotiation of services before funds are settled from the member's account.

Looking now at the process flow of FIG. 6, the Accept Payment process begins at a start step 602 where a provider accesses the MSA platform via a Provider Portal. At step 604, the provider would enter the member's information to search for the member's MSA account. Exemplary criteria that a provider may use to search for a valid MSA account member may include MSA account card number, all or part of the SSN of the member, member name, and member date of birth. Of course, other search criteria may also be employed with the disclosed MSA platform. At step 606, it is determined if the member has been found in the system, or perhaps a group of members having similar search criteria. If the member is not found, the process will return to where the provider may again search for the member. If the member's profile is found, the specific member may be selected from one or more search results, at step 608.

At step 610, it is determined if the provider will manually enter the bill attributes or provide a bill in an electronic file format. For example, the provider may employ the 8371 standard employed by most major Electronic Medical Records systems. If the provider chooses to enter the payment request information manually, the process moves to step 612. The process may then check for any error in the manually entered information, at step 614. If any error is found, the error(s) is displayed to the provider at step 616, and the process would return to allow the provider to reenter the billing information. If no errors are found, the process would move on to a payment adjudication process (step 624), which is described in detail with reference to FIG. 7. If the provider chooses to enter the billing information electronically, the electronic medical record is parsed at step 618. The process may then check for any error in the electronic record at step 620. If any error is found, the error(s) is displayed to the provider at step 622, and the process would return to allow the provider to again upload the electronic record file again. If no errors are found, the process would move on to the payment adjudication process of step 624.

Once a bill has been entered into the system, the component line items of the bill are processed against the “Crosswalk” logic layer to look up dollar values for the services being rendered, determine MSA compensability, determine Medicare coverage applicability, examine the bill against state-specific pricing, and to red flag edits and completeness. As mentioned above, the specifics of the adjudication process are discussed with reference to FIG. 7. In accordance with the disclosed principles, billed services are segmented out by MSA Compensable to Injury, Medicare Compensable (covered), or Client Liability (not covered by either MSA account or Medicare Allowable. Specifically, at step 626, line items in the bill categories may be displayed, along with any re-pricing that may be applicable. At step 628, it is determined if the bill contains MSA applicable items. If so, the provider may wish to capture payment for the MSA Compensable procedures, they may select the option to pre-authorize the MSA-covered amount at step 630. For example, the total amount shown in the MSA Compensable items group may be sent as an “Authorized, No Capture” request to the MSA account card Payments Processor. A record of this request would then be stored for reference later in the payment capture portion of the process. If there are no MSA-eligible items, or once MSA-eligible items have been pre-authorized, the process then determines if the bill contains any Medicare billable items at step 632. If so, the process may be designed to print or otherwise provide a 1500 Form for such expenses. If no Medicare-eligible items are found, or once any 1500 Forms have been provided, the process moves a payment capture portion of the Accept Payment process.

At step 636, MSA account member's card is swiped at the provider's point of sale device or payment software for the exact amount previously sent for the Pre-Authorization Capture, if any, in step 630. At step 638, it is determined if the authorization amount exactly matches the pre-authorization amount. If not, an error may be displayed to the provider at step 640. If there is a match, it is then determined if the MSA account has sufficient funds at step 642. If the MSA account does not have sufficient funds, then an error may be displayed to the provider at step 640. If the MSA account is determined to have sufficient funds, then the payment is approved and captured by the provider account at step 644, and the Access Payment process is completed.

### Pharmacy Benefits Manager Payments

The above payment request description discusses payment presentment by healthcare providers; however, the disclosed MSA platform may also be employed if the member employs a PBM. If a PBM is used by the member, the member may be given a unique pharmacy BIN number when enrolling with the MSA platform. Such a number may even be embossed on the member's card or otherwise associated with the member's specific payment vehicle linked to his MSA account. During the enrollment process, information about the member's settlement, which is collected by the MSA platform as described above, may be passed along to the PBM to create a patient pharmacy profile. The patient's pharmacy profile indicates which pharmaceuticals are covered by Medicare, thus enabling the PBM to adjudicate requests for pharmaceuticals.

The member may then present prescriptions, their member number and BIN number at a pharmacy affiliated with the PBM. The pharmacy will then contact the MSA platform, or perhaps an MSA pharmacy benefit management partner would contact the MSA platform, to determine if the prescription can be paid from the member's MSA account and if any re-pricing should occur as described herein. The MSA platform or the MSA PBM partner will then instruct the pharmacy whether the prescription is authorized, and if so, to not collect payment from the MSA member. If a payment is authorized from the member's account, then MSA or the MSA PBM will charge the member's payment account. The PBM, via the card issuing processor, may then deduct and settle the funds with the pharmacy from the member account. As a result, payments for covered pharmaceuticals are not made from the member's MSA account to the pharmacy, and instead are made from the PBM directly to the pharmacy. Accordingly, the pharmacy does not need to be affiliated with the MSA platform. Alternatively, pharmacies may elect to be providers with the disclosed MSA platform, and is such embodiments a PBM may not be employed.

### Payment Adjudication

The adjudication process of the disclosed MSA platform is the automated manner by which payments from a member's MSA account are processed, as well as a number of other features. Generally speaking, the adjudication process may involve a number of checks on the medical procedures and equipment submitted by healthcare providers. Such checks may include a validation check, to determine if the expense is a covered Medicare expense. In addition, a bundling check may be performed, which determines what Common Procedural Terminology (CPT) code may be billed together and which ones cannot. Another check that the adjudication process may perform is a fee schedule check, which determines what fees may be charged in each specific state. Additionally, other fee amount-based checks may be made, such as determining if a PPO network member charges a lesser fee for the same service performed. For example, if a PPO offers a lower price than the CMS allowable rate, then MSA might use the lower PPO value to price the cost of the billed procedure. Yet another check that may be performed is a zone check, in which the adjudication process may determine whether the state in which the procedure was performed is a single zone or multi-zone state, as determined by the zip code. Then, depending on the zone, an alteration of the eligible amount may be provided. In addition to these exemplary checks, an adjudication process implemented with an MSA platform as disclosed herein may perform additional or alternative checks on the payment amount(s) submitted by providers.

What follows is a more specific exemplary embodiment of an adjudication process that may be implemented with the disclosed MSA platform. Although the adjudication process discussed below is described with respect to the adjudication of MSA account-related expenses, the disclosed adjudication techniques are applicable to other industries as well where eligibility for the payment of services and or goods is determined before payment is authorized. For example, adjudication in accordance with the disclosed principles may be implemented for any type of insurance related claim. The type of insurance claim (auto, workers' compensation or tort) would determine the rules and regulations to be applied to a particular incoming claim. In the example of a workers' compensation claim, the adjudication process would use rules/regulations, tables and pricing lookups specific to workers' compensation in order to reduce the total amount charged, if possible, and thus the appropriate adjusted amount would be paid from the member's account. Other types of insurance claims, such as PIP (automobile insurance related) claims could also be adjudicated, and would have their own unique rules and regulations that can also processed by the disclosed adjudication engine, and then applied to the PIP claim. Regardless of insurance claim type, adjudication as disclosed herein will work on a pre-swipe or post swipe manner to adjudicate the bill as discussed herein, and ensure timely payment, and payment of the proper amount depending on the applicable rules/regulations/laws, of a claim.

For MSA account-based applications, the adjudication platform may employ publicly available data tables. Examples of publicly available data tables include, but are not limited to, Fee Tables for all the states, Fee Tables for various regions within states, Fee Tables for PPO networks, and Fee Tables for Medicare/Medicaid allowable expense amounts. The disclosed adjudication process combines the publicly available data with proprietary database tables developed specifically for use by the MSA platform. Exemplary data that may be generated and stored in proprietary tables includes, but is not limited to, specific information regarding a member's injury, and the allowable medical expenses related to such an injury. More specifically, the ICD9 codes entered during the enrollment process dictate which CPT codes and pharmaceutical expenses will be allowed. When an expense is presented for adjudication, either by manual entry on the provider portal or by 837 file upload, as described above, the MSA platform uses the patient/member enrollment profile to reference against the proprietary data tables. The adjudication engine then performs a series of checks to determine if the expense is compensable.

FIG. 7 illustrates a flow diagram 700 for an exemplary adjudication process conducted with the disclosed MSA platform and in accordance with the disclosed principles. The exemplary adjudication process begins at a start step 702. At step 704, the location, for example, region and state, for the provided service is determined. This information is typically provided by the service provider during the payment capture process. At step 706, a check is done for Medicare allowable items. Then, at step 708, the adjudication process validates the fields and codes that identifying the medical service.

At step 710, it is determined if the billed charge(s) includes any CPT codes. If so, CPT code value lookup occurs in step 712. At step 714, it is determined if the billed charge(s) includes any Healthcare Common Procedure Coding System (HCPCS) codes. If so, HCPCS code value lookup occurs in step 716. At step 718, it is determined if the billed charge(s) includes any Diagnosis related group (DRG) codes. If so, DRG code value lookup occurs in step 720. At step 722, it is determined if the billed charge(s) includes any Durable Medical Equipment (DME) codes. If so, DME code value lookup occurs in step 724.

At step 726, it is determine if the billed charge(s) includes any National Drug Codes (NDC). If so, NDC code value lookup occurs in step 728. In this case, PBM external resources may be employed, if needed, at step 730.

At step 732, a check may be made to determine if any duplicate billing is presented in the current payment request. At step 734, tables, such as the fee tables, etc. discussed above, are checked for confirmation of the amount(s) charged for the medical services provided. If there is a difference in the billed amount the amount allowed for a service, the MSA platform can then adjust the amount to be authorized for that particular service. Additionally, a “PPO check” may be performed, where codes for medical service (e.g., CPT codes) may be checked against participating PPO networks. If the PPO network has a lower cost for the service, then the process may use that cost to re-price the transaction amount for that service.

At step 736, the adjudication process determines if the service or procedure or medical equipment sought to be billed is an MSA compensable procedure. If not, the transaction for that item may be refused. If there are MSA compensable items in the presented bill, then various items may then be grouped for payment based on coding, at step 738. At step 740, the process determines if any warnings should be displayed to the provider requesting payment for a bill. If so, such warnings are displayed to the provider, for example, via the Provider Portal, at step 742. At step 744, it is determined if any errors have occurred during the adjudication process. If so, such errors are displayed to the provider at step 746. In addition, such errors may be flagged for review by an administrator of the disclosed MSA platform at step 748.

At step 750, once all the allowable charges for all MSA-eligible procedures/equipment are determine and adjusted, as needed, the values and any groupings for multiple eligible items may then be presented to the provider. Then, at step 752, the sub-totals for all of the MSA compensable items is sent to the pre-authorization process, such as the exemplary process illustrated and described with reference to FIG. 6. At this point, the adjudication process may end at an end step 754. It should be understood that the adjudication process flow illustrated in FIG. 7 is only an exemplary process, and other similar processes for use with an MSA platform implemented in accordance with the disclosed principles, which may have more or lesser steps, or even different steps than the process of FIG. 7, also fall within the broad scope of the present disclosure.

### Administration Portal

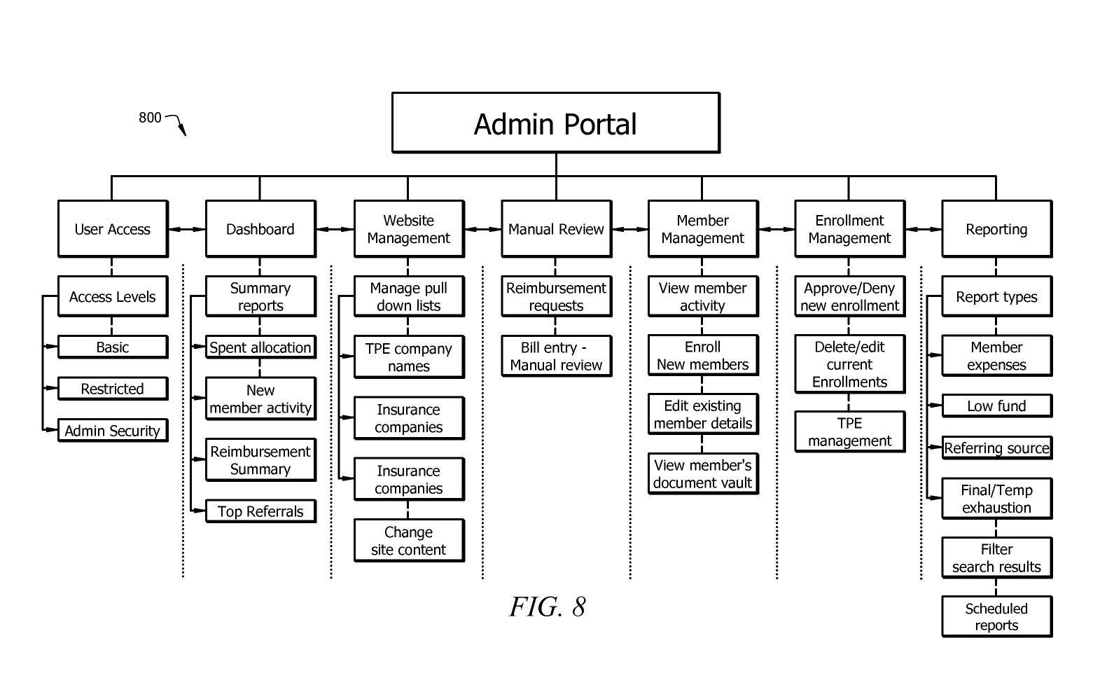

Looking now at FIG. 8, illustrated is a block diagram for an Administration Portal 800 for use with an MSA solution system or process implemented in accordance with the disclosed principles. The Administration Portal 800 provides the backbone network to monitor and manage every aspect of the MSA platform. Each administrator of the disclosed MSA platform may be assigned a username, password and security level in order to gain access to the Administration Portal. Depending on user access, level certain areas of the Portal might not be available to every administrative user. For example, basic level access may be given to all employees with the capability of looking up member details, account balance and view expense reports. Restricted security level may allow some employees to do everything in the basic level category as well as higher level functions such as approve new enrollments, access to additional reports, schedule reports, and manage pre-populated drop down lists. An administrative security level may also be employed that has no restrictions to those administrative users with those access rights.

Another area of the Administration Portal may be a Dashboard, which may display a number of administrative links/pages accessible by administrative users logged into the Administration Portal. More specifically, summary reports may be accessible for display by a user. For example, an overview of all activities year-to-date may be displayed, perhaps using pie charts and bar charts. These may show running totals for all member activities with the ability to drill down into additional details. In addition, new member activities may be selected for viewing, as well as reimbursement summaries and even top referrals. Of course other types of activities may also be accessible and displayed to users via the Dashboard for the Administration Portal.

Another area accessible to users of the Administration Portal may be a website management area. Such an area gives administrative users the capability of adding site content and managing pre-populated list content. For example, such lists may include lists of third party entity companies and insurance companies working with the MSA platform. Another area of the Administration Portal may be a manual review area, which might allow administrative users to review certain reimbursement request or bill entries made into the MSA system. Yet another may be a member management area. In such an area, an administrative user may be able to view all of the members' activities in the MSA platform, handle the enrollment of new members, and even view or edit existing member details. In addition, such an area might allow users to view or edit specific documents in a member's document vault.

An enrollment management area may also be provided via the Administration Portal. In such an area, administrative user may new member enrollments, such as approve or deny membership in the MSA system. User could also delete or edit current enrollments, such as expired accounts or members that are no longer eligible for whatever reason. Likewise, administrative users could also manage the enrollment for third party entities, such as insurance carriers and the like. Also, the Administration Portal could include a reporting area. In such an area, administrative users could generate reports of various types related to membership or perhaps the MSA platform itself. Reports or search results may be generating using any of a number of filtering capabilities. Scheduled reports may also be created so that certain items are reported on a regular basis, if needed.

In addition, administrators of the MSA platform, as the provider of a solution for self-administration of MSA accounts, would have the capability to compile, at the request of a member, transaction histories associated with the member, which can then be populated into an annual CMS report, which must include, among other things, details regarding the disbursements from each MSA account, and made available to the member. The member could be given the opportunity to edit the CMS report and submit said report to CMS himself or herself via email or mail.

Overall, the disclosed administrator for restricted-use financial accounts, such as MSA accounts, may be configured to offer a variety of reporting options for members, service providers, administrators and regulatory offices, such as CMS or the Social Security Administration. Such reports of the usage of the financial accounts are instrumental in communicating daily, monthly and annual activity. System data may be collected from the separate portals and aggregated into a database for running scheduled and on-demand reports, by either members or administrators. The type of data collected can be, but is not limited to, member expenses, saving reports, low fund alerts, temp/final exhaustion, new/pending enrollments, completed enrollments and annual attestation CMS report. Some reports are mandated by third party entities in order to remain complaint, and thus the capability to generate activity reports can be used to demonstrate compliance with applicable rules and regulations. As discussed above, one such report could be an annual member expense report mandated by CMS, known as the Annual Attestation Report. This report must be received on an annual basis by CMS in order for a member to remain complaint with Medicare guidelines. The disclosed MSA solution will be capable of generating such annual compliance reports, either manually or automated for electronic submission to the appropriate required government agency.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method of administering a restricted-use financial account, the method comprising:
receiving personal information regarding a user, the personal information including a personal status of the user;
facilitating the creation of a restricted-use financial account based on the received personal information, the portion of the personal information regarding the personal status of the user restricting expenses payable from the financial account;
facilitating funding of the financial account with funds for use by the user based on the personal status of the user;
associating a payment vehicle with the financial account for use by the user for payment of eligible expenses from the financial account;
receiving a payment request from a provider of goods or services to be provided for the benefit of the user;
determining if the goods or services related to the payment request is an eligible expense payable from the financial account; and
authorizing payment for the eligible expense to the provider from the financial account.

2. A method according to claim 1, wherein determining if the goods or services is an eligible expense comprises determining if the goods or services are directly related to the personal status of the user.

3. A method according to claim 1, wherein the personal status of the user comprises an injury suffered by the user, and wherein the funds for use by the user based on the personal status comprise an award, settlement, lump sum, combination thereof or other payment payable to the user based on the injury suffered by the user.

4. A method according to claim 3, wherein the goods or services to be provided for the benefit of the user is a medical service, medical equipment, or pharmaceutical for treatment of the user's injury.

5. A method according to claim 3, wherein determining if the goods or services related to the payment request is an eligible expense payable from the financial account further comprises determining if the goods or services would be eligible for payment by Medicare or Medicaid for treatment of the user's injury if no funds were present for use by the user based on the injury.

6. A method according to claim 1, wherein determining if the goods or services is an eligible expense comprises determining if the goods or services comply with predetermined legal requirements for eligible expenses.

7. A method according to claim 6, wherein the personal status of the user comprises an injury suffered by the user and the financial account is a Medicare Set Aside (MSA) account, and wherein determining if the goods or services comply with predetermined legal requirements comprises determining if the goods or services comply with Centers for Medicare and Medicaid Services (CMS) guidelines.

8. A method according to claim 1, wherein receiving personal information regarding a user comprises receiving personal information regarding a user from a third party entity creating the financial account on behalf of the user.

9. A method according to claim 1, further comprising adjusting the payment amount for an eligible expense payable from the financial account, and authorizing payment of the adjusted amount to the provider from the financial account.

10. A method according to claim 9, wherein the personal status of the user comprises an injury suffered by the user, and wherein the adjusting is based on determining a cost of the goods or services from a database of usual and customary costs for the goods or services.

11. A system for administering a restricted-use financial account, the system comprising:
a user interface for receiving personal information regarding a user, the personal information including a personal status of the user;
a database for storing the received personal information;
a computer platform having a restricted-use financial account associated with the database and created based on the received personal information, the portion of the personal information regarding the personal status of the user restricting expenses payable from the financial account;
funds for use by the user based on the personal status of the user and located in the financial account;
a provider interface for receiving a payment request from a provider of goods or services to be provided for the benefit of the user; and
wherein the computer platform is configured to:
associate a payment vehicle with the financial account for use by the user for payment of eligible expenses from the financial account;
determine if the goods or services related to the payment request is an eligible expense payable from the financial account, and
authorize payment for the eligible expense to the provider from the financial account.

12. A system according to claim 11 wherein the computer platform is configured to determine if the goods or services is an eligible expense by determining if the goods or services are directly related to the personal status of the user.

13. A system according to claim 11, wherein the personal status of the user comprises an injury suffered by the user, and wherein the funds for use by the user based on the personal status comprise an award, settlement, lump sum, combination thereof or other payment payable to the user based on the injury suffered by the user.

14. A system according to claim 13, wherein the goods or services to be provided for the benefit of the user is a medical service, medical equipment, or pharmaceutical for treatment of the user's injury.

15. A system according to claim 13, wherein the computer platform is configured to determine if the goods or services are an eligible expense by determining if the goods or services would be eligible for payment by Medicare or Medicaid for treatment of the user's injury if no funds were present for use by the user based on the injury.

16. A system according to claim 11, wherein the computer platform is configured to determine if the goods or services are an eligible expense by determining if the goods or services comply with predetermined legal requirements for eligible expenses.

17. A system according to claim 16, wherein the personal status of the user comprises an injury suffered by the user and the financial account is a Medicare Set Aside (MSA) account, and wherein the computer platform determining if the goods or services comply with predetermined legal requirements comprises determining if the goods or services comply with Centers for Medicare and Medicaid Services (CMS) guidelines.

18. A system according to claim 11, wherein the enrollment interface is further configured to receive the personal information regarding a user from a third party entity creating the financial account on behalf of the user.

19. A system according to claim 11, wherein the computer platform is further configured to adjust the payment amount for an eligible expense payable from the financial account, and authorize payment of the adjusted amount to the provider from the financial account.

20. A system according to claim 19, wherein the personal status of the user comprises an injury suffered by the user, and wherein the computer platform adjusts the payment amount by determining a cost of the goods or services from a database of usual and customary costs for the goods or services.

21. A system according to claim 11, wherein the user interface comprises a member portal facilitating access by the user to his financial account, to information regarding the administration of his financial account, and to generate reports regarding use of his financial account.

22. A system according to claim 11, wherein the provider interface comprises a provider portal facilitating access by a provider to his payment requests and to information regarding the administration of his payment requests.

23. A system according to claim 11, wherein the personal status of the user comprises an injury suffered by the user and the provider is a pharmacy providing an eligible pharmaceutical for treatment of the user's injury, and wherein the computer platform is further configured to authorize payment for the eligible pharmaceutical from the financial account directly to the pharmacy or to a pharmacy benefits manager rather than the pharmacy such that the pharmacy benefits manager makes direct payment to the pharmacy.

24. A method of administering a Medicare Set Aside (MSA) account, the method comprising:
receiving personal information regarding a user, the personal information including information on an injury of the user;
facilitating the creation of an MSA account based on the received personal information;
facilitating the funding of the MSA account with funds for use by the user based on the injury of the user;
associating a payment vehicle with the MSA account for use by the user for payment of eligible medical expenses from the MSA account;
receiving a payment request from a medical provider of goods or services to be provided for treatment of the user's injury;
determining if the goods or services related to the payment request is a Medicare-eligible medical expense payable from the MSA account;
determining if the payment request amount for a Medicare-eligible expense should be adjusted and thereafter adjusting the payment amount based on the determination; and
authorizing payment for the eligible medical expense to the medical provider from the MSA account.

25. A method according to claim 24, wherein the goods or services to be provided for the benefit of the user is a medical service, medical equipment, or pharmaceutical for treatment of the user's injury.

26. A method according to claim 24, wherein determining if the goods or services is a Medicare-eligible medical expense comprises determining if the goods or services comply with Centers for Medicare and Medicaid Services (CMS) guidelines.

27. A method according to claim 26, further comprising generating reports regarding expenditures paid from the MSA account.

28. A method according to claim 24, wherein receiving personal information regarding a user comprises receiving personal information regarding a user from a third party entity creating the MSA account on behalf of the user.

29. A method according to claim 24, wherein the determining if the payment request amount should be adjusted comprises determining a cost of the goods or services from a database of usual and customary costs for the goods or services.

30. A method according to claim 29, wherein the usual and customary costs for the goods or services is based on geographic location of where the goods or services are to be provided to the user or where the user sustained the injury.
